(19) United States
(12) Patent Application Publication
(10) Pub. No.: US 2019/0179126 A1
(43) Pub. Date: Jun. 13, 2019

(54) LENS

(71) Applicant: SAMSUNG ELECTRO-MECHANICS CO., LTD., Suwon-si (KR)

(72) Inventors: Jae Hyun KIM, Suwon-si (KR); Man Sub SHIN, Suwon-si (KR); Young Su JIN, Suwon-si (KR); Jun Hwan YOO, Suwon-si (KR); In Gun KIM, Suwon-si (KR)

(73) Assignee: SAMSUNG ELECTRO-MECHANICS CO., LTD., Suwon-si (KR)

(21) Appl. No.: 16/205,359

(22) Filed: Nov. 30, 2018

(30) Foreign Application Priority Data
Dec. 12, 2017 (KR) 10-2017-0170635

(51) Int. Cl. G02B 13/18

(52) U.S. Cl. CPC G02B 13/18

(57) ABSTRACT

A lens includes a refractive portion refracting incident light, a flange portion disposed at an edge of the refractive portion, and a light shielding portion shielding incident light and extending from the flange portion towards the refractive portion.

### CROSS-REFERENCE TO RELATED APPLICATION(S)

This application claims benefit of priority to Korean Patent Application No. 10-2017-0170635 filed on Dec. 12, 2017 in the Korean Intellectual Property Office, the disclosure of which is incorporated herein by reference in its entirety.

### BACKGROUND

### 1. Field

The present disclosure relates to a lens for a camera configured to reduce a flare phenomenon.

### 2. Description of Related Art

When an object is imaged by a camera, light incident at an unspecified angle may cause reflections in a lens, and a flare phenomenon, causing problems in an image. A flare phenomenon may be reduced using an aperture disposed between lenses, but a flare phenomenon may not be completely removed. Also, an aperture may significantly reduce the amount of light incident through a lens, which may lead to reduction in relative illumination (RI).

Thus, it may be necessary to develop a lens which can reduce a flare phenomenon without reducing relative illumination.

### SUMMARY

An aspect of the present disclosure is to provide a lens configured to reduce a flare phenomenon.

According to an aspect of the present disclosure, a lens includes a refractive portion refracting incident light, a flange portion disposed at an edge of the refractive portion, and a light shielding portion shielding incident light and extending from the flange portion towards the refractive portion.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a cross-sectional diagram illustrating a lens according to an exemplary embodiment in the present disclosure;

FIG. 2 is a cross-sectional diagram illustrating a combined lens assembly including a lens in FIG. 1;

FIG. 3 is a cross-sectional diagram illustrating a lens according to another exemplary embodiment in the present disclosure; and

FIG. 4 is a cross-sectional diagram illustrating a lens according to another exemplary embodiment in the present disclosure.

### DETAILED DESCRIPTION

Hereinafter, embodiments of the present disclosure will be described as follows with reference to the attached drawings.

With respect to terms used in exemplary embodiments, the terms are selected in view of a function of each element, and the terms used in the description are not to be taken in a limiting sense.

In the exemplary embodiments, when an element is mentioned as being “connected” to another component, this may mean that the element is directly connected to another component, and may also mean that the element is indirectly connected to another component with an intervening element therebetween. Also, it will be understood that when a portion “includes” an element, it may further include another element, not excluding another element, unless otherwise indicated.

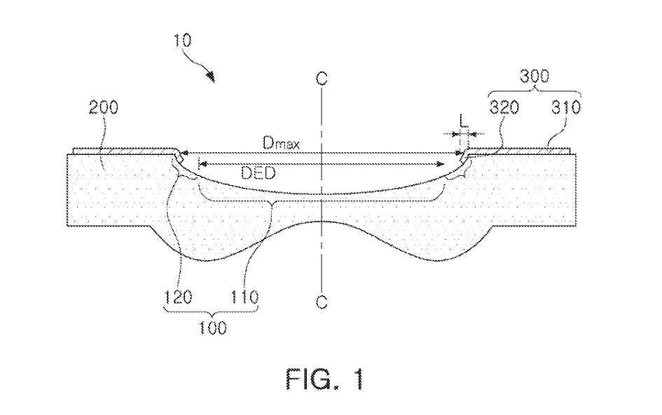

In the description below, a lens according to an exemplary embodiment will be described with reference to FIG. 1.

A lens 10 according to the exemplary embodiment may include a refractive portion 100, a flange portion 200, and a light shielding portion 300.

The refractive portion 100 may pass and refract light. For example, the refractive portion 100 may have a concave surface or a convex surface in the lens 10. By the refractive portion 100 configured as above, the lens 10 may have positive refractive force or negative refractive force. The refractive portion 100 may include a valid region 110 and an invalid region 120. For example, with reference to an optical center (C-C), an overall area of the refractive portion 100 may be the valid region 110 configured as an aspheric surface, and the rest of the area of the refractive portion 100 may be the invalid region 120 configured to not refract light. In the exemplary embodiment, the invalid region 120 may be formed on an edge of the valid region 110.

The flange portion 200 may be configured to not pass or refract light. For example, the flange portion 200 may be a planar portion in the lens 10. However, the flange portion 200 may not be exactly planar. For instance, the flange portion 200 may include a protrusion, a groove, a stepped portion, and the like, to be coupled to an adjacent lens. The flange portion 200 configured as above may be disposed at an edge of the refractive portion 100, and by the flange portion 200, the lens 10 may be properly disposed, and the lenses may be properly combined.

The light shielding portion 300 may shield light incident at an unspecified angle. For example, the light shielding portion 300 may be disposed at the flange portion 200 which does not refract light, and may be disposed in the refractive portion 100 to reduce a flare phenomenon caused by internal reflections in the lens 10. The light shielding portion 300 may be, for example, disposed to include an overall boundary area between the refractive portion 100 and the flange portion 200.

The light shielding portion 300 may be divided into a first light shielding portion 310 and a second light shielding portion 320 in accordance with locations in which the light shielding portion 300 is formed. For example, the first light shielding portion 310 may be disposed in the flange portion 200, and the second light shielding portion 320 may be disposed to be in contact with the refractive portion 100. The first light shielding portion 310 may entirely cover one surface of the flange portion 200. The first light shielding portion 310 configured as above may shield unnecessary light incident through the flange portion 200 effectively. The second light shielding portion 320 may be disposed to cover the invalid region 120 in the refractive portion 100. For example, the second light shielding portion 320 may cover an overall area of the invalid region 120 except for the valid region 110 in the refractive portion 100. Accordingly, a length L of the second light shielding portion 320 may satisfy an equation as below.

0.2≤L/(Dmax−DED)≤1.0 [Equation]

Here, “Dmax” may be a maximum diameter of the refractive portion 100, and “DED” may be a maximum diameter of the valid region 110.

The light shielding portion 300 may be manufactured using a solid material including a light shielding material, or a liquid material including a light shielding material. If the light shielding portion 300 is formed of a solid material, the light shielding portion 300 may be attached to the refractive portion 100 and the flange portion 200 through an adhesion process, a fusion process, or the like, and if the light shielding portion 300 is formed of a liquid material, the light shielding portion 300 may be disposed in the refractive portion 100 and the flange portion 200 by a printing method, and the like. The light shielding portion 300 may have a certain thickness in both examples above, and a member for maintaining a gap disposed between the lenses may thus be omitted.

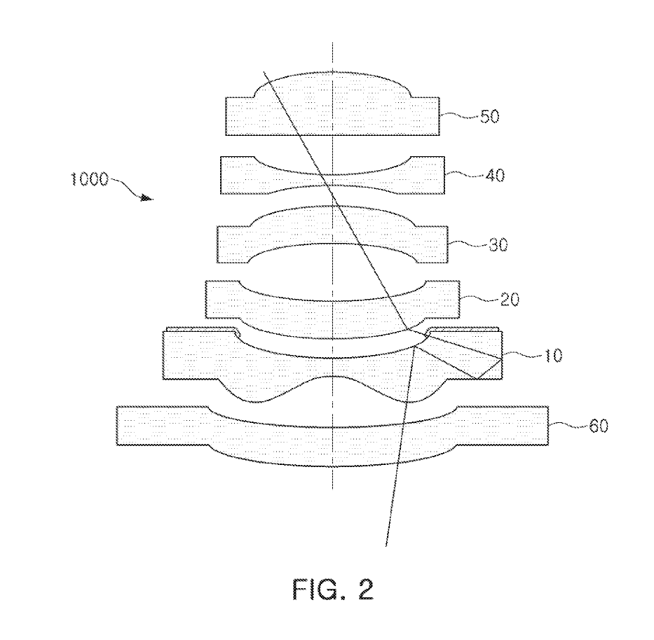

In the description below, a lens assembly including a lens according to an exemplary embodiment will be described with reference to FIG. 2.

The lens 10 in the exemplary embodiment may be implemented by any lens included in the lens assembly 1000. For example, the lens 10 may be disposed between a lens 20 and a lens 60. As another example, in the lens assembly 1000, the lens 10 may be disposed most closely to an object. As yet another example, the lens 10 may be disposed most closely to a top surface (an imaging plane) in the lens assembly 1000. In any examples above, the lens 10 may shield light incident at an unspecified angle and reduce a flare phenomenon.

Table 1 below relates to a comparison between a general lens and a lens having a light shield portion. As indicated in Table 1 below, a general lens has a significantly high density of flare formed by light incident at an unspecified angle. However, the lens satisfying the aforementioned equation (embodiments 3 to 7) has a significantly reduced flare density. Meanwhile, “relative illumination” in Table 1 is a percentage ratio (%) of the amount of light incident to a lens when an aperture is not present.

TABLE 1

| | L/(Dmax − | Flare Density | Relative |
|---|---|---|---|
| | DED)*100(%) | (10⁻¹⁴ W) | Illumination (%) |
| Comparative | 0% | 33100 | 100% |
| Example | | | |
| Embodiment 1 | 8% | 32600 | 100% |
| Embodiment 2 | 15% | 26200 | 100% |
| Embodiment 3 | 23% | 10400 | 100% |
| Embodiment 4 | 30% | 7.97 | 100% |
| Embodiment 5 | 38% | 4.33 | 100% |
| Embodiment 6 | 45% | 3.29 | 100% |
| Embodiment 7 | 100% | 2.96 | 100% |

In the description below, a lens according to another example embodiment will be described. The same elements described in the aforementioned exemplary embodiments will be indicated by the same reference numerals, and the detailed descriptions of the same elements will not be repeated.

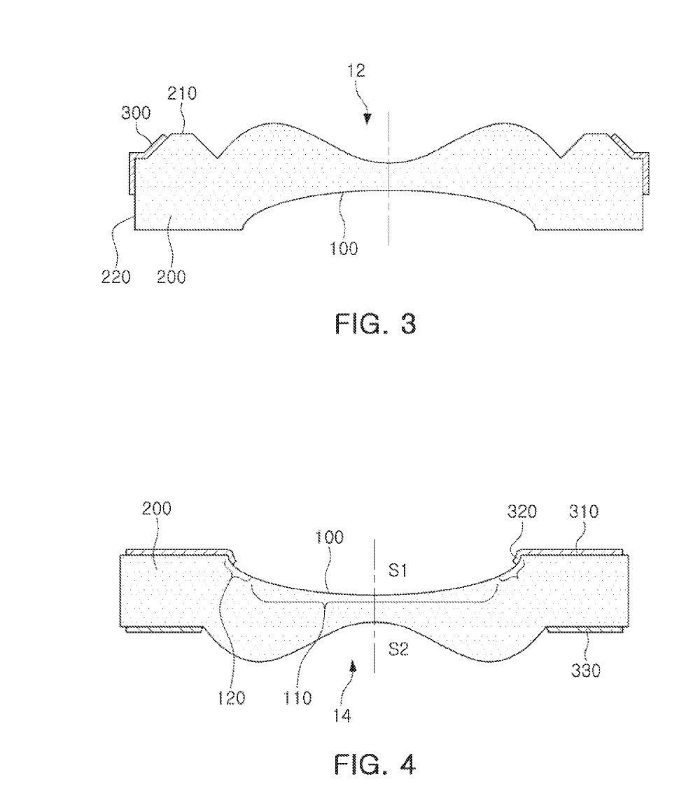

A lens according to another exemplary embodiment will be described with reference to FIG. 3.

A lens 12 according to the exemplary embodiment may include a protrusion 210 as illustrated in FIG. 3. The protrusion 210 may be disposed in a flange portion 200, and may work as a means to couple the lens to an adjacent lens.

In the exemplary embodiment, a light shielding portion 300 may be disposed in the flange portion 200 and the protrusion 210. More specifically, the light shielding portion 300 may be disposed on one side portion of the protrusion 210 and a circumferential surface 220 of the flange portion 200.

The lens 12 configured as above may effectively reduce a flare phenomenon caused by internal reflections in a lens barrel.

In the description below, a lens according to another exemplary embodiment will be described with reference to FIG. 4.

A lens 14 according to the exemplary embodiment may be different from the lens 10 in the aforementioned exemplary embodiment in that, in the lens 14, the light shielding portion 300 is disposed on both surfaces of the lens 14.

The light shielding portion 300 may be formed on one surface (a surface close to an object) of the lens 14 and on the other surface (a surface close to an upper surface) in different forms. For example, on one surface of the lens 14, a first light shielding portion 310 and a second light shielding portion 320 may be formed in the flange portion 200 and the refractive portion 100, respectively, and on the other surface of the lens 14, the light shielding portion 300 may only be formed in the flange portion 200.

According to the aforementioned exemplary embodiments, a flare phenomenon caused by light incident at an unspecified angle may be reduced.

Further, the lens in the exemplary embodiments may not need a separate light shielding member and a separate gap maintaining member. Accordingly, a weight of a camera module including a plurality of lenses may be significantly reduced.

While the exemplary embodiments have been shown and described above, it will be apparent to those skilled in the art that modifications and variations could be made without departing from the scope of the present invention as defined by the appended claims.

What is claimed is:

1. A lens, comprising:
a refractive portion refracting incident light;
a flange portion disposed at an edge of the refractive portion; and
a light shielding portion shielding incident light and extending from the flange portion towards the refractive portion.

2. The lens of claim 1, wherein the light shielding portion comprises a first light shielding portion disposed in the flange portion, and a second light shielding portion disposed in the refractive portion.

3. The lens of claim 1, wherein the refractive portion comprises a valid region and an invalid region.

4. The lens of claim 1, wherein the flange portion comprises a protrusion configured to be in contact with an adjacent lens.

5. The lens of claim 1, wherein the light shielding portion is disposed in the flange portion and the invalid region, in the refractive portion.

6. The lens of claim 1, wherein the refractive portion has a concave surface.

7. The lens of claim 1, wherein the refractive portion has a convex surface.

8. The lens of claim 1, wherein the lens satisfies an equation 0.2≤L/(Dmax−DED)≤1.0, where Dmax is a maximum diameter of the refractive portion, DED is a maximum diameter of the valid region in the refractive portion, L is a length of the light shielding portion extending from a boundary between the flange portion and the refractive portion towards the refractive portion.

9. The lens of claim 1, wherein the light shielding portion is disposed on a circumferential surface of the flange portion.
